(19) United States
(12) Patent Application Publication
(10) Pub. No.: US 2026/0120311 A1
(43) Pub. Date: Apr. 30, 2026

(54) AUGMENTED REALITY DEVICE FOR PROVIDING AUGMENTED REALITY SERVICE MATCHED TO CONTEXT OF REAL-WORLD SPACE AND OPERATING METHOD THEREFOR

(71) Applicant: SAMSUNG ELECTRONICS CO., LTD., Suwon-si (KR)

(72) Inventors: Deokho KIM, Suwon-si (KR); Gunill LEE, Suwon-si (KR); Wonwoo LEE, Suwon-si (KR); Jiwon JEONG, Suwon-si (KR)

(73) Assignee: SAMSUNG ELECTRONICS CO., LTD., Suwon-si (KR)

(21) Appl. No.: 19/431,289

(22) Filed: Dec. 23, 2025

Related U.S. Application Data
(63) Continuation of application No. PCT/KR2024/006754, filed on May 17, 2024.

(30) Foreign Application Priority Data
Jun. 26, 2023 (KR) 10-2023-0082206

(51) Int. Cl. G06T 7/70; G02B 27/01; G06F 3/01; G06F 3/04847; G06V 40/10; G06V 40/20

(52) U.S. Cl. CPC G06T 7/70; G02B 27/0101; G02B 27/017; G06F 3/011; G06F 3/017; G06F 3/04847; G06V 40/10; G06V 40/28; G02B 2027/0138; G02B 2027/0141; G02B 2027/0178

(57) ABSTRACT

Provided are an augmented reality device for providing an augmented reality service matched to a real-world space, and an operating method thereof. The augmented reality device may recognize a plurality of objects in a real-world space from an image obtained through a camera, recognize a relative position relationship including positions and directions between the plurality of recognized objects, and display, at a preset position, a virtual object representing information related to the plurality of recognized objects, based on information about a prestored relative position relationship.

This application is a continuation of International Application No. PCT/KR2024/006754, filed on May 17, 2024, which is based on and claims priority to Korean Patent Application No. 10-2023-0082206, filed on Jun. 26, 2023, in the Korean Intellectual Property Office, the disclosures of which are incorporated by reference herein in their entireties

### TECHNICAL FIELD

### Background Art

### 1. Field

The present disclosure relates to an augmented reality device for providing an augmented reality service matched to a context of a real-world space, and an operating method thereof. More particularly, the present disclosure relates to an augmented reality device for recognizing a context of a space in which a user wearing the augmented reality device is located and providing an augmented reality service that displays information corresponding to the recognized context, and an operating method thereof.

### 2. Description of Related Art

Augmented reality is a technology for overlaying and displaying a virtual image on a real-world object or a physical environment space of the real world, and augmented reality devices (e.g., smart glasses) using augmented reality technology are being usefully employed in everyday life for purposes such as information retrieval, navigation, and camera shooting. Particularly, smart glasses are also worn as fashion items and are mainly used for outdoor activities.

By using an augmented reality device, information about real-world spaces may be recorded and observed in all areas of everyday life. A user who does an activity such as work, gaming, leisure, or rest while wearing an augmented reality device may have to personally perform an action of determining and executing an application to be used in a particular space as the user moves. When the user moves a lot, an action of predetermining and executing an application to be used in a particular space may be cumbersome and may degrade the user experience.

### SUMMARY

Additional aspects will be set forth in part in the description which follows and, in part, will be apparent from the description, or may be learned by practice of the presented embodiments.

An aspect of the present disclosure provides a method of providing, by an augmented reality device, an augmented reality service matched to a real-world space. An operating method of the augmented reality device may include recognizing a plurality of objects in the real-world space from an image obtained via a camera. The operating method of the augmented reality device may include recognizing a relative position relationship including positions and directions between the plurality of recognized objects. The operating method of the augmented reality device may include displaying, at a preset position, a virtual object representing information related to the plurality of recognized objects, based on information about a prestored relative position relationship.

Another aspect of the present disclosure provides an augmented reality device for providing an augmented reality service matched to a real-world space. The augmented reality device of the present disclosure may include a camera configured to obtain an image by photographing the real-world space, at least one processor including processing circuitry, memory storing one or more instructions, and a display unit. The one or more instructions, when executed by the at least one processor individually or collectively, may cause the AR device to recognize a plurality of objects in a real-world space from an image obtained through the camera. The one or more instructions, when executed by the at least one processor individually or collectively, may cause the AR device to recognize a relative position relationship including positions and directions between the plurality of recognized objects and display, through the display, at a preset position, a virtual object representing information related to the plurality of recognized objects, based on information about a relative position relationship prestored in the memory.

Another aspect of the present disclosure provides a non-transitory computer-readable storage medium storing at least one instruction that, when executed by at least one processor, cause the augmented reality device to perform operations comprising recognizing a plurality of objects in a real-world space from an image obtained through a camera, recognizing a relative position relationship including positions and directions between the plurality of recognized objects, and displaying, at a preset position, a virtual object representing information related to the plurality of recognized objects, based on information about a prestored relative position relationship.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram for describing an operation of providing, by an augmented reality device according to an embodiment of the present disclosure, an augmented reality service matched to a context of a real-world space;

FIG. 2 is a flowchart illustrating an operating method of an augmented reality device according to an embodiment of the present disclosure;

FIG. 3 is a block diagram illustrating components of an augmented reality device according to an embodiment of the present disclosure;

FIG. 4 is a flowchart illustrating a method of identifying, by an augmented reality device according to an embodiment of the present disclosure, a matched spatial context preset, based on a scene graph of a real-world space;

FIG. 5A is a diagram illustrating a scene graph obtained by an augmented reality device according to an embodiment of the present disclosure, based on distances between objects;

FIG. 5B is a diagram illustrating a scene graph obtained by an augmented reality device according to an embodiment of the present disclosure, based on direction vectors of objects;

FIG. 5C is a diagram illustrating a scene graph obtained by an augmented reality device according to an embodiment of the present disclosure, based on sign vectors of objects;

FIG. 6 is a diagram illustrating an operation of measuring, by an augmented reality device according to an embodiment of the present disclosure, a similarity of a scene graph to identify a spatial context preset matched to a spatial context of a real-world space;

FIG. 7 is a diagram illustrating an operation of measuring, by an augmented reality device according to an embodiment of the present disclosure, a similarity of a sub-graph of a scene graph to identify a spatial context preset matched to a spatial context of a real-world space;

FIG. 8 is a flowchart illustrating an operation performed by an augmented reality device according to an embodiment of the present disclosure, depending on whether a spatial context preset matched to a spatial context of a real-world space is identified;

FIG. 9 is a diagram illustrating an operation of merging, by an augmented reality device according to an embodiment of the present disclosure, a new spatial context with an existing spatial context preset;

FIG. 10 is a flowchart illustrating a method of displaying, by an augmented reality device according to an embodiment of the present disclosure, a virtual object matched to a spatial context;

FIG. 11 is a diagram illustrating an operation of displaying, by an augmented reality device according to an embodiment of the present disclosure, a virtual object matched to a spatial context;

FIG. 12 is a flowchart illustrating a method of displaying, by an augmented reality device according to an embodiment of the present disclosure, a new virtual object; and

FIG. 13 is a diagram for describing an operation of displaying, by an augmented reality device according to an embodiment of the present disclosure, a new virtual object.

### DETAILED DESCRIPTION

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the present disclosure. Thus, the terms used herein should be understood not as simple names but based on the meanings of the terms and the overall description of the present disclosure.

As used herein, the singular forms “a,” “an,” and “the” may include the plural forms as well, unless the context clearly indicates otherwise. Unless otherwise defined, all terms (including technical or scientific terms) used herein may have the same meanings as commonly understood by those of ordinary skill in the art of the present disclosure.

Throughout the present disclosure, when something is referred to as “including” an element, one or more other elements may be further included unless specified otherwise. Also, as used herein, terms such as “units” and “modules” may refer to units that perform at least one function or operation, and the units may be implemented as hardware or software or a combination of hardware and software.

The expression “configured to (or set to)” used herein may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some case, the expression “a system configured to . . . ” may mean that the system is “capable of . . . ” along with other devices or components. For example, “a processor configured to (or set to) perform A, B, and C” may refer to a dedicated processor (e.g., an embedded processor) for performing a corresponding operation, or a general-purpose processor (e.g., a central processing unit (CPU) or an application processor) capable of performing a corresponding operation by executing one or more software programs stored in memory.

Also, herein, when an element is referred to as being “connected” or “coupled” to another element, the element may be directly connected or coupled to the other element and may also be connected or coupled to the other element through one or more other intervening elements therebetween unless otherwise specified.

Herein, “augmented reality” may mean displaying a virtual image in a physical environment space of the real world or displaying a real-world object and a virtual image together.

Herein, an ‘augmented reality device’ may be a device capable of representing augmented reality and may include, for example, not only ‘augmented reality glasses in the shape of glasses worn by a user on his/her face, but also a head-mounted display (HMD) apparatus worn by a user on his/her head, or an augmented reality helmet.

Herein, a ‘spatial context’ may be information representing the characteristics of a physical environment space in the real world and may refer to, for example, characteristic information of a space for an activity such as work, study, leisure, gaming, or rest. In an embodiment of the present disclosure, the spatial context may represent the relative position relationship between a plurality of objects in a real-world space. In an embodiment of the present disclosure, the spatial context may include information about the positions and directions between a plurality of real-world objects.

Herein, a function related to “artificial intelligence” may be operated through a processor and memory. The processor may include one or more processors. In this case, the one or more processors may include a general-purpose processor such as a central processing unit (CPU), an application processor (AP), or a digital signal processor (DSP), a dedicated graphics processor such as a graphic processing unit (GPU) or a vision processing unit (VPU), or a dedicated artificial intelligence processor such as a neural processing unit (NPU). The one or more processors may control input data to be processed according to a predefined operation rule or artificial intelligence model stored in the memory. Alternatively, in a case that the one or more processors include a dedicated artificial intelligence processor, the dedicated artificial intelligence processor may be designed with a hardware structure specialized for processing a particular artificial intelligence model.

The predefined operation rule or artificial intelligence model may be characterized as being generated through training. Here, being generated through training may mean that a basic artificial intelligence model is trained by a learning algorithm by using a plurality of pieces of training data and accordingly a predefined operation rule or artificial intelligence model set to perform a desired feature (or purpose) is generated. Such training may be performed in a machine itself in which artificial intelligence according to the present disclosure is performed, or may be performed through a separate server and/or system. Examples of the learning algorithm may include, but are not limited to, supervised learning, unsupervised learning, semi-supervised learning, or reinforcement learning.

Herein, the ‘artificial intelligence model’ may include a plurality of neural network layers. Each of the plurality of neural network layers may have a plurality of weights (weight values) and may perform a neural network operation through an operation between the plurality of weights and the operation result of a previous layer. The plurality of weights of the plurality of neural network layers may be optimized by the learning results of the artificial intelligence model. For example, the plurality of weights may be updated such that a loss value or a cost value obtained by the artificial intelligence model during the learning process may be reduced or minimized. The artificial neural network model may include Deep Neural Network (DNN) and may include, for example, Convolutional Neural Network (CNN), Recurrent Neural Network (RNN), Restricted Boltzmann Machine (RBM), Deep Belief Network (DBN), Bidirectional Recurrent Deep Neural Network (BRDNN), or Deep Q-Network; however, the present disclosure is not limited thereto.

Herein, ‘vision recognition’ may mean image signal processing that inputs an image into an artificial intelligence model and recognizes (detects) an object from the input image, classifies an object into a particular category, or segments an object through inference using the artificial intelligence model. In an embodiment of the present disclosure, vision recognition may mean image processing that obtains classification information of the object or obtains type information thereof by recognizing, by using an artificial intelligence model, an object from an image captured by camera.

Hereinafter, embodiments of the present disclosure will be described in detail with reference to the accompanying drawings so that those of ordinary skill in the art may easily implement the present disclosure. However, the present disclosure may be embodied in many different forms and should not be construed as being limited to the embodiments set forth herein.

Hereinafter, embodiments of the present disclosure will be described in detail with reference to the accompanying drawings.

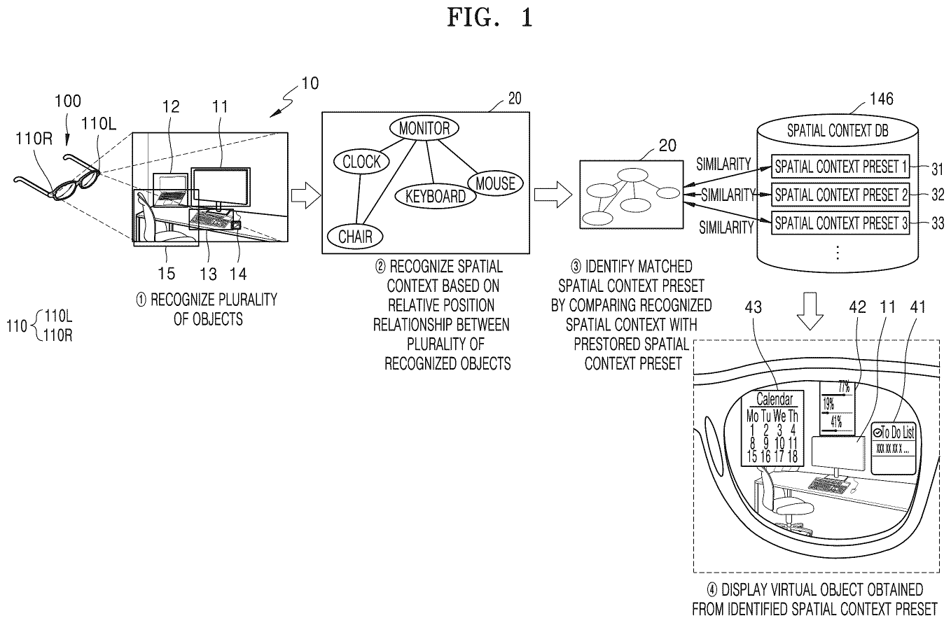

FIG. 1 is a conceptual diagram for describing an operation of providing, by an augmented reality device 100 according to an embodiment of the present disclosure, an augmented reality service matched to a context of a real-world space 10.

The augmented reality device 100 may be a device capable of representing augmented reality and may include, for example, augmented reality glasses in the shape of glasses that a user wears on his/her face. Although the augmented reality device 100 is illustrated as augmented reality glasses in FIG. 1, the present disclosure is not limited thereto. For example, the augmented reality device 100 may be implemented as a head-mounted display (HMD) apparatus worn on a head region, an augmented reality helmet, or the like.

Referring to FIG. 1, the augmented reality device 100 may include a camera 110, and the camera 110 may include a left-eye camera 110L and a right-eye camera 110R. When the user wears the augmented reality device 100, the left-eye camera 110L may be located adjacent to the user's left eye and may photograph the real-world space 10 to obtain a left-eye image. When the user wears the augmented reality device 100, the right-eye camera 110R may be located adjacent to the user's right eye and may photograph the real-world space 10 to obtain a right-eye image. In an embodiment of the present disclosure, the left-eye camera 110L and the right-eye camera 110R may constitute a stereo camera that obtains a three-dimensional position coordinate value of an object through triangulation based on a two-dimensional image obtained in an area where the fields of view overlap each other and the position relationship between the cameras. Although a plurality of cameras 110L and 110R are illustrated and described as including two cameras in FIG. 1, the present disclosure is not limited thereto. The augmented reality device 100 may include three or more cameras.

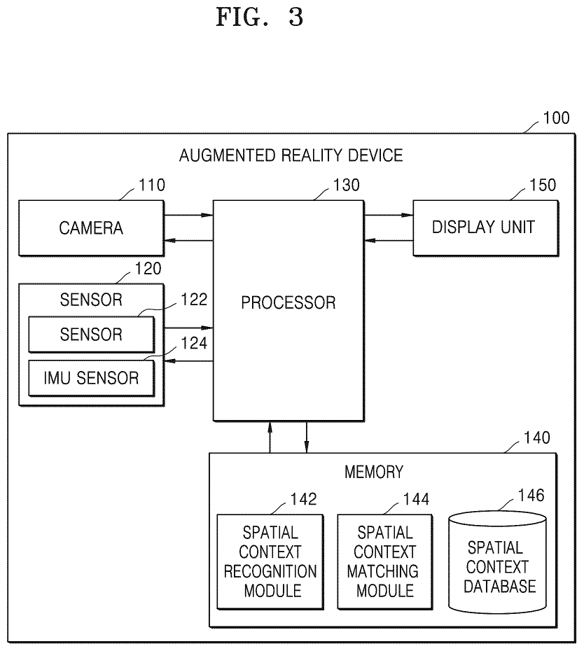

Only the minimum components for describing the function and/or operation of the augmented reality device 100 are illustrated in FIG. 1; however, the components included in the augmented reality device 100 are not limited to those illustrated in FIG. 1. The components of the augmented reality device 100 will be described below in detail with reference to FIG. 3.

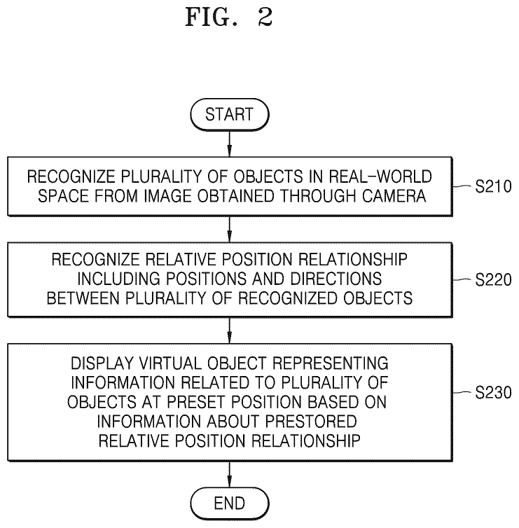

In the embodiment illustrated in FIG. 1, the augmented reality device 100 may recognize a plurality of objects 11, 12, 13, 14, and 15 in the real-world space 10 from an image obtained through the left-eye camera 110L and the right-eye camera 110R (operation 1)), recognize a spatial context of the real-world space 10 based on the relative position relationship between the plurality of recognized objects 11, 12, 13, 14, and 15 (operation 2), identify a matched spatial context preset by comparing the recognized spatial context with a spatial context preset prestored in memory 140 (see FIG. 3) (operation 3), and display a virtual object obtained from the identified spatial context preset. Hereinafter, the function and/or operation of the augmented reality device 100 will be described in detail with reference to FIGS. 1 and 2 together.

FIG. 2 is a flowchart illustrating an operating method of an augmented reality device 100 according to an embodiment of the present disclosure.

In operation S210, the augmented reality device 100 may recognize a plurality of objects in a real-world space from an image obtained through a camera. Referring to FIG. 1 together, the augmented reality device 100 may include a left-eye camera 110L and a right-eye camera 110R, may obtain a left-eye image by photographing the real-world space 10 using the left-eye camera 110L, and may obtain a right-eye image by photographing the real-world space 10 using the right-eye camera 110R. The augmented reality device 100 may recognize a plurality of objects 11, 12, 13, 14, and 15 in the real-world space 10 from the left-eye image and the right-eye image by performing vision recognition using an artificial intelligence model. In an embodiment of the present disclosure, the artificial intelligence model may be a deep neural network model trained to recognize an object from an image and output classification information of the object through a supervised learning that applies an image as an input and applies a label value representing classification information of an object as a ground truth. The deep neural network model may be, for example, a convolutional neural network (CNN) model; however, the present disclosure is not limited thereto. In the embodiment illustrated in FIG. 1, the augmented reality device 100 may input an image into a deep neural network model, recognize a plurality of objects 11, 12, 13, 14, and 15 from the image through inference using the deep neural network model, and obtain ‘monitor’ as classification information of a first object 11, ‘notebook’ as classification information of a second object 12, ‘keyboard’ as classification information of a third object 13, ‘mouse’ as classification information of a fourth object 14, and ‘chair’ as classification information of a fifth object 15.

In operation S220 of FIG. 2, the augmented reality device 100 may recognize a relative position relationship including positions and directions between the plurality of recognized objects. In an embodiment of the present disclosure, the augmented reality device 100 may recognize a spatial context of a real-world space based on the relative position relationship between the plurality of objects. Herein, the ‘spatial context’ may be information representing the characteristics of a physical environment space in the real world and may refer to, for example, characteristic information of a space for an activity such as work, study, leisure, gaming, or rest. In an embodiment of the present disclosure, the spatial context may include a scene graph representing the relative position relationship of the plurality of objects.

Referring to FIG. 1 together, the augmented reality device 100 may obtain three-dimensional position coordinate information of each of the plurality of objects 11, 12, 13, 14, and 15 recognized from the image and obtain the relative position relationship of the plurality of objects 11, 12, 13, 14, and 15 based on the obtained three-dimensional position coordinate information. In an embodiment of the present disclosure, the augmented reality device 100 may obtain three-dimensional position coordinate values of an object including depth values (z-axis coordinate information) of the plurality of objects 11, 12, 13, 14, and 15 through a stereo vision method by using the left-eye image obtained from the left-eye camera 110L and the right-eye image obtained from the right-eye camera 110R. The augmented reality device 100 may obtain a relative position relationship about the three-dimensional distance and direction between the plurality of objects 11, 12, 13, 14, and 15 based on the obtained three-dimensional position coordinate values. In an embodiment of the present disclosure, the relative position relationship may include information about at least one of a distance, a direction vector, and a sign vector in a three-dimensional space between the plurality of objects 11, 12, 13, 14, and 15. In an embodiment of the present disclosure, the augmented reality device 100 may obtain a scene graph 20 based on the classification information or type information of the plurality of objects 11, 12, 13, 14, and 15 and the relative position relationship between the plurality of objects 11, 12, 13, 14, and 15. The scene graph 20 may include a plurality of nodes representing the classification information or type of each of the plurality of objects 11, 12, 13, 14, and 15 and a plurality of edges representing the relative position relationship between the plurality of nodes.

In operation S230 of FIG. 2, the augmented reality device 100 may display a virtual object representing information related to the plurality of recognized objects at a preset position based on information about a prestored relative position relationship. In an embodiment of the present disclosure, the augmented reality device 100 may identify a spatial context preset matched to the recognized spatial context based on the relative position relationship between the plurality of objects. In an embodiment of the present disclosure, the augmented reality device 100 may prestore a spatial context preset representing the characteristics of a space, such as work, shared space, game, leisure, and rest, based on the relative position relationship between the objects. The augmented reality device 100 may measure a similarity by comparing a spatial context recognized from the image with a prestored spatial context preset and identify a spatial context preset matched to the recognized spatial context based on the measured similarity.

Referring to FIG. 1 together, the augmented reality device 100 may include a spatial context database 146 storing spatial context presets (31, 32, 33, . . . ). In an embodiment of the present disclosure, the spatial context presets (31, 32, 33, . . . ) stored in the spatial context database 146 may include a scene graph representing the relative position relationship of objects according to characteristics of a space. For example, a first spatial context preset 31 may include a scene graph about the relative position relationship of objects representing a work space, a second spatial context preset 32 may include a scene graph about the relative position relationship of objects representing a game space, and a third spatial context preset 33 may include a scene graph about the relative position relationship of objects representing a rest space. The augmented reality device 100 may measure a similarity by comparing the scene graph 20 representing the relative position relationship between the plurality of objects 11, 12, 13, 14, and 15 recognized from the image with the scene graphs of a plurality of spatial context presets (31, 32, 33, . . . ) prestored in the spatial context database 146. The augmented reality device 100 may identify a spatial context preset matched to the spatial context among the plurality of spatial context presets (31, 32, 33, . . . ) by identifying a scene graph of which the measured similarity exceeds a preset threshold.

In an embodiment of the present disclosure, the augmented reality device 100 may obtain a virtual object from the position relationship preset and display the obtained virtual object at a preset position. In an embodiment of the present disclosure, the augmented reality device 100 may obtain a virtual object from the spatial context preset matched to the recognized spatial context based on the relative position relationship between the plurality of objects and obtain display position information of the virtual object. Herein, the ‘virtual object’ may refer to a virtual graphic object including a text, an image, or a combination thereof representing information that is related to an object in a real-world space or is provided by an application executed by the augmented reality device 100. In an embodiment of the present disclosure, the virtual object may be displayed in the form of a graphical user interface (GUI) or a widget. In an embodiment of the present disclosure, the augmented reality device 100 may display a virtual object at a preset position based on information about the display position of the virtual object.

Referring to FIG. 1 together, the augmented reality device 100 may obtain virtual objects 41, 42, and 43 by loading the virtual objects 41, 42, and 43 from the spatial context preset identified from the spatial context database 146 and display the obtained virtual objects 41, 42, and 43 at a preset display position. The augmented reality device 100 may obtain information about the display position of the virtual objects 41, 42, and 43 from the spatial context preset. In an embodiment of the present disclosure, the display position of the virtual objects 41, 42, and 43 may be preset as a relative position with respect to the position of the plurality of objects 11, 12, 13, 14, and 15 in the real-world space 10 or as a particular relative position with respect to the position of the augmented reality device 100. In the embodiment illustrated in FIG. 1, a first virtual object 41 may be a to-do list widget for work to do and may be preset to be displayed adjacent to the right side of the monitor, and a second virtual object 42 may be a graphic UI representing the work progress and may be preset to be displayed adjacent to the upper side of the monitor. A third virtual object 43 may be a calendar widget and may be preset to be displayed adjacent to the left upper end of a lens unit of the augmented reality device 100.

The augmented reality device 100 may display the virtual objects 41, 42, and 43 based on preset display position information. In the embodiment illustrated in FIG. 1, the augmented reality device 100 may display the first virtual object 41 at a position spaced apart from the right side of the monitor by a preset position and display the second virtual object 42 at a position spaced apart from the upper side of the monitor by a preset position. The augmented reality device 100 may display the third virtual object 43 such that the third virtual object 43 is displayed at the left upper end of the lens based on the position of the augmented reality device 100.

The augmented reality device 100 may record and observe information about the real-world space 10 in all areas of everyday life. The user who does an activity such as work, gaming, leisure, or rest while wearing the augmented reality device 100 may have to personally perform an action of determining and executing an application to be used in a particular space as the user moves. When the user moves a lot, an action of predetermining and executing an application to be used in a particular space may be cumbersome and may degrade the user experience.

The present disclosure may provide an augmented reality device 100 and an operating method thereof that may recognize the relative position relationship between a plurality of objects in a real-world space 10 where the user is located and provide and display information corresponding to the recognized relative position relationship to provide a continuous augmented reality experience to the user.

The augmented reality device 100 of the present disclosure may recognize the plurality of objects 11, 12, 13, 14, and 15 included in the real-world space 10, recognize the relative position relationship between the plurality of recognized objects 11, 12, 13, 14, and 15, and display the virtual objects 41, 42, and 43 related to the plurality of objects 11, 12, 13, 14, and 15 at a preset display position based on prestored position relationship information. Accordingly, the augmented reality device 100 of the present disclosure may provide a technical effect of improving the efficiency of everyday life or work by enhancing the user's recognition ability. According to an embodiment of the present disclosure, the augmented reality device 100 may allow the user to individually configure and manage environments for multiple spaces having the same spatial context, like Work From Anywhere, thus providing the continuity of work, games, leisure, rest, or the like in various environments. Also, according to an embodiment of the present disclosure, the augmented reality device 100 may provide a consistent user experience for each spatial context and may recognize the environment in accordance with the configuration of the currently-located real-world space 10 to continuously provide information (e.g., the virtual objects 41, 42, and 43).

FIG. 3 is a block diagram illustrating components of an augmented reality device 100 according to an embodiment of the present disclosure.

Referring to FIG. 3, the augmented reality device 100 may include a camera 110, a sensor 120, a processor 130, memory 140, and a display unit 150. The camera 110, the sensor 120, the processor 130, the memory 140, and the display unit 150 may be electrically and/or physically connected to each other. Only the components for describing the operation of the augmented reality device 100 are illustrated in FIG. 3; however, the components included in the augmented reality device 100 are not limited to those illustrated in FIG. 3. In an embodiment of the present disclosure, the augmented reality device 100 may further include a communication interface for performing data communication with an external device or server. In an embodiment of the present disclosure, the augmented reality device 100 may be implemented as a portable device, and in this case, the augmented reality device 100 may further include a battery that supplies driving power to the camera 110, the sensor 120, the processor 130, and the display unit 150.

The camera 110 may be configured to obtain an image of an object by photographing the object in a real-world space. The camera 110 may include a lens module, an image sensor, and an image processing module. The camera 110 may obtain a still image or a video of an object by using an image sensor (e.g., CMOS or CCD). The video may include a plurality of image frames that are consecutively obtained by photographing the object through the camera 110. The image processing module may encode a still image including a single image frame obtained through the image sensor or video data including a plurality of image frames and transmit the same to the processor 130.

In an embodiment of the present disclosure, the camera 110 may include a left-eye camera that is located adjacent to the user's left eye and configured to obtain a left-eye image by photographing a real-world space and a right-eye camera that is located adjacent to the user's right eye and configured to obtain a right-eye image by photographing the real-world space, when the user wears the augmented reality device 100. The left-eye camera and the right-eye camera may constitute a stereo camera. However, the present disclosure is not limited thereto, and the camera 110 may be implemented as any type of camera well-known in the art, such as an RGB-depth camera, a time-of-flight (ToF) camera, a grayscale camera, or an infrared camera.

The sensor 120 may include a position sensor 122 and an inertial measurement unit (IMU) sensor 124.

The position sensor 122 may be configured to obtain position information of the augmented reality device 100 in a three-dimensional space. The position sensor 122 may include, for example, a global positioning system (GPS) sensor for obtaining three-dimensional position coordinate value information of the augmented reality device 100.

The IMU sensor 124 may be configured to measure the movement speed, direction, angle, and gravitational acceleration of the augmented reality device 100. The IMU sensor 124 may further include an acceleration sensor, a gyro sensor, and a geomagnetic sensor (magnetometer). The acceleration sensor (accelerometer) may be configured to measure acceleration according to a change in movement when a dynamic force such as acceleration force, a vibration force, or an impact force is generated in the augmented reality device 100. In an embodiment of the present disclosure, the acceleration sensor may be configured as a three-axis accelerometer for measuring acceleration in row, lateral, and height directions. The gyro sensor (gyroscope) may be configured to measure an angular velocity that is a rotation change amount of the augmented reality device 100. In an embodiment of the present disclosure, the gyro sensor may include a three-axis angular velocity sensor for measuring roll, pitch, and yaw angular velocities.

The processor 130 may execute one or more instructions of the program stored in the memory 140. The processor 130 may include hardware components for performing arithmetic, logic, and input/output operations and image processing. Although the processor 130 is illustrated as one element in FIG. 3, the present disclosure is not limited thereto. In an embodiment of the present disclosure, the processor 130 may include one or more elements. One or more processors included in the processor 140 may include circuitry such as a system-on-chip (SoC) or an integrated circuit (IC). The processor 130 may include a general-purpose processor such as a central processing unit (CPU), an application processor (AP), or a digital signal processor (DSP), a dedicated graphic processor such as a graphic processing unit (GPU) or a vision processing unit (VPU), or a dedicated artificial intelligence processor such as a neural processing unit (NPU). The processor 130 may process input data according to a predefined operation rule or an artificial intelligence model by executing at least one instruction or program code stored in the memory 140. Alternatively, in a case that the processor 130 includes a dedicated artificial intelligence processor, the dedicated artificial intelligence processor may be designed with a hardware structure specialized for processing a particular artificial intelligence model.

The processor 130 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing a variety of the recited/disclosed functions, e.g., in a distributed manner. At least one processor may execute program instructions to achieve or perform various functions.

The memory 140 may include, for example, at least one type of storage medium among flash memory type, hard disk type, multimedia card micro type, card type memory (e.g., SD or XD memory), random access memory (RAM), static random access memory (SRAM), read-only memory (ROM), electronically erasable programmable read-only memory (EEPROM), programmable read-only memory (PROM), or optical disk.

The memory 140 may store instructions related to functions and/or operations that allow the augmented reality device 100 to recognize relative position relationship between a plurality of objects in a real-world space, identify position relationship information matched to the recognized relative position relationship, and display a virtual object obtained from the identified position relationship information at a preset display position to provide an augmented reality service matched to the real-world space. In an embodiment of the present disclosure, the memory 140 may store at least one of instructions, an algorithm, a data structure, program code, and an application program that may be read by the processor 130. The instructions, algorithm, data structures, and program code stored in the memory 140 may be implemented, for example, in programming or scripting languages such as C, C++, Java, and Assembler.

The memory 140 may store instructions, an algorithm, a data structure, or program code related to a spatial context recognition module 142, a spatial context matching module 144, and a spatial context database 146. The ‘module’ included in the memory 140 may refer to a unit for processing a function or operation performed by the processor 130 and may be implemented as software such as instructions, an algorithm, a data structure, or program code.

In the following embodiments, the processor 130 may be implemented by executing the instructions or program codes stored in the memory 140.

The spatial context recognition module 142 may be configured with instructions or program code related to a function and/or operation of recognizing a plurality of objects in a real-world space from an image and recognizing a spatial context based on the relative position relationship between the plurality of recognized objects. By executing the instructions or program code of the spatial context recognition module 142, the processor 130 may recognize a plurality of objects in a real-world space from an image obtained by the camera 110. In an embodiment of the present disclosure, the spatial context recognition module 142 may include an artificial intelligence model trained to recognize an object from an image. The artificial intelligence model may include a deep neural network model trained to recognize an object through a supervised learning that applies a bounding box image, which may be recognized as an object from tens of thousands or hundreds of millions of input images, as input data and applies a label value about a ground truth of an object in the bounding box as an output. The deep neural network model may be implemented as an object recognition model such as a convolutional neural network model, a region-based convolutional neural network model (R-CNN), YOLO v4, CenterNet, or MobileNet; however, the present disclosure is not limited thereto.

However, the present disclosure is not limited thereto, and markers, for example, a visual que such as QR code, are attached to objects in a real-world space, and the processor 130 may recognize the objects based on the visual ques obtained through the camera 110.

The processor 130 may recognize a spatial context based on a relative position relationship including positions and directions of the plurality of recognized objects. In an embodiment of the present disclosure, the ‘relative position relationship’ may include information about at least one of a distance, a direction vector, and a sign vector in a three-dimensional space between the plurality of objects. Herein, the ‘spatial context’ may be information representing the characteristics of a physical environment space in the real world and may refer to, for example, characteristic information of a space for an activity such as work, study, leisure, gaming, or rest.

In an embodiment of the present disclosure, the processor 130 may obtain three-dimensional position coordinate information of each of a plurality of objects from an image obtained from the camera 110 and obtain a relative position relationship between the plurality of objects based on the obtained three-dimensional position coordinate information of the plurality of objects. The camera 110 may include a left-eye camera and a right-eye camera, and the processor 130 may obtain three-dimensional position coordinate information including a depth value of an object through a stereo vision method by using a left-eye image obtained from the left-eye camera and a right-eye image obtained from the right-eye camera. However, the present disclosure is not limited thereto, and in an embodiment of the present disclosure, the camera 110 may include a time-of-flight (ToF) camera, and the processor 130 may obtain three-dimensional position coordinate information of an object by using the ToF camera. The processor 130 may obtain a relative position relationship about distances and directions in a three-dimensional space between the plurality of objects based on the obtained three-dimensional position coordinate values of the object. In an embodiment of the present disclosure, information about the direction may be obtained in the form of a direction vector or a sign vector. The processor 130 may recognize a spatial context based on the relative position relationship between the recognized objects.

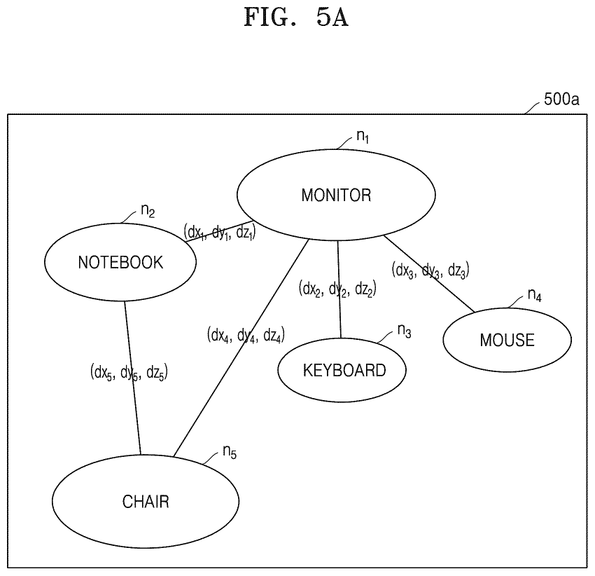

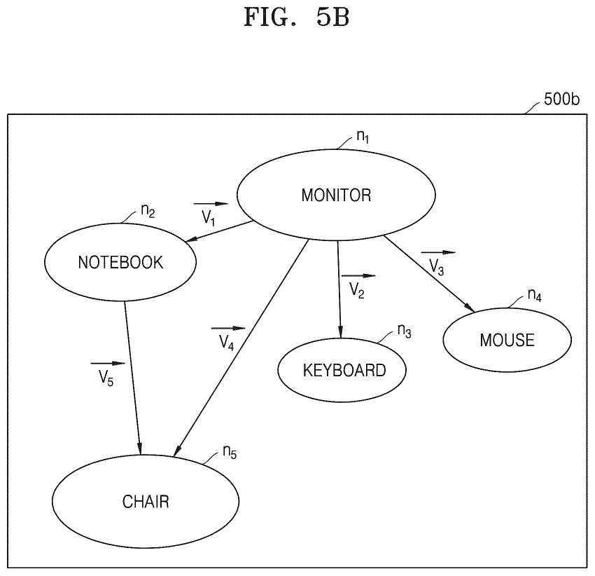

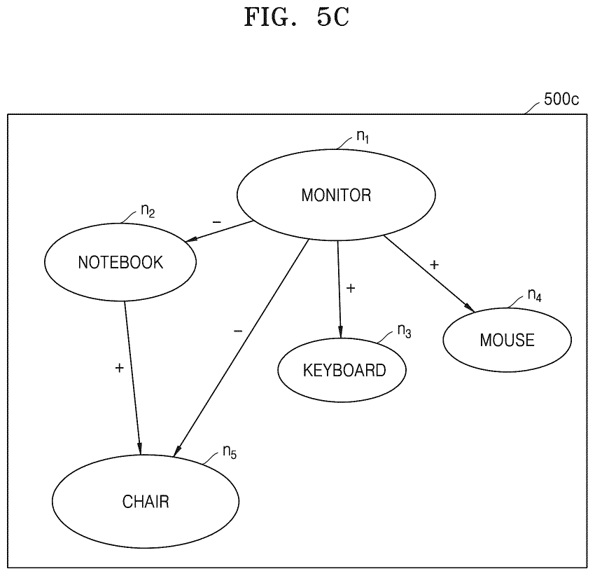

In an embodiment of the present disclosure, the processor 130 may obtain a scene graph representing the relative position relationship of the plurality of objects. The ‘scene graph’ may include nodes representing the classified categories or types of the plurality of objects recognized from the image and edges representing the relative position relationship between the nodes of the plurality of objects. In an embodiment of the present disclosure, the edge may represent a relative position relationship including at least one of a distance, a direction vector, or a sign vector in a three-dimensional space between a plurality of nodes. The scene graph will be described below in detail with reference to FIGS. 5A to 5C.

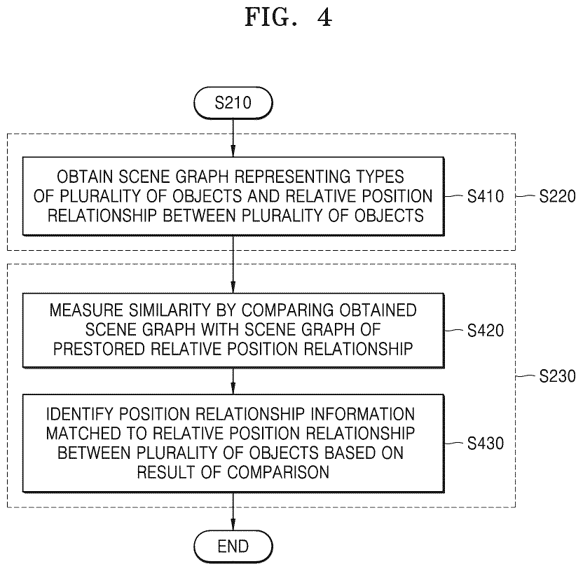

The spatial context matching module 144 may be configured with instructions or program code related to a function and/or operation of comparing a recognized spatial context with a spatial context preset prestored in the spatial context database 146 and identifying a spatial context preset matched to the recognized spatial context. The spatial context database 146 may store at least one spatial context preset that is preset for at least one spatial characteristic. By executing the instructions or program code of the spatial context matching module 144, the processor 130 may compare a spatial context recognized from an image with at least one spatial context preset prestored in the spatial context database 146 and identify a spatial context preset matched to the spatial context based on the comparison result. In an embodiment of the present disclosure, the processor 130 may measure a similarity by comparing a scene graph of a spatial context with a scene graph of at least one spatial context preset prestored in the spatial context database 146. The processor 130 may identify a spatial context preset matched to the spatial context based on the result of comparing the measured similarity with a preset threshold. A particular embodiment in which the processor 130 measures the similarity between a scene graph of a spatial context and a scene graph of a prestored spatial context preset and identifies a spatial context preset matched to the spatial context based on the measured similarity will be described below in detail with reference to FIGS. 4 to 6.

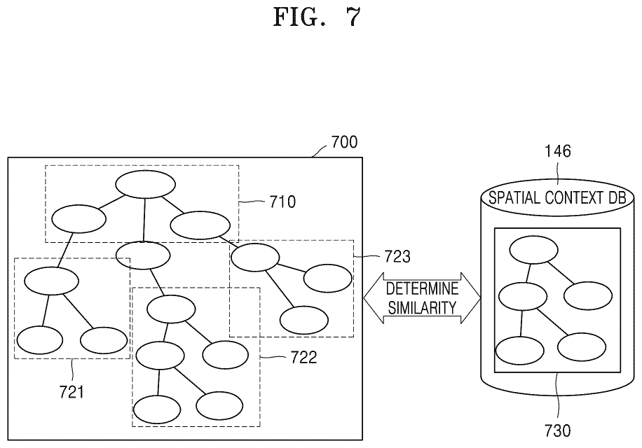

In an embodiment of the present disclosure, the scene graph may include at least one sub-graph having a hierarchical structure. In this case, the processor 130 may measure a similarity by comparing at least one sub-graph with a scene graph of a spatial context prestored in the spatial context database 146 and identify a spatial context preset having a scene graph of which the measured similarity exceeds a preset threshold. A particular embodiment in which the processor 130 measures the similarity of a scene graph formed in a hierarchical structure and identifies a spatial context preset based on the measured similarity will be described below in detail with reference to FIG. 7.

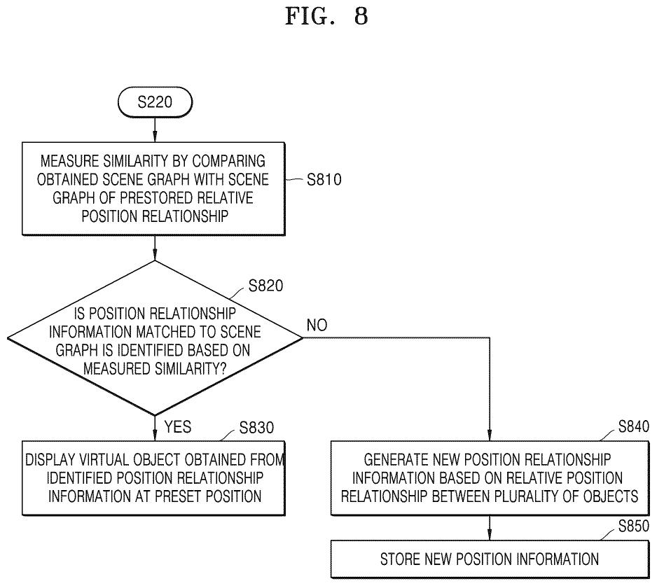

In an embodiment of the present disclosure, in a case that a spatial context preset matched to a spatial context recognized from an image is not identified, the processor 130 may generate a new spatial context preset based on information about a relative position relationship between a plurality of objects constituting the spatial context. The function and/or operation of the processor 130 depending on whether the spatial contexts match each other will be described below in detail with reference to FIG. 8.

The spatial context database 146 may be a storage device storing at least one spatial context preset for at least one spatial characteristic and may include a nonvolatile memory. The nonvolatile memory may refer to a storage medium that may store and retain information even when power is not supplied thereto and may use the stored information again when power is supplied thereto. The nonvolatile memory may include, for example, at least one of a flash memory, a hard disk, a solid state drive (SSD), a multimedia card micro type memory, a card type external memory (e.g., an SD or XD memory), a read only memory (ROM), a magnetic disk, or an optical disk. Although the spatial context database 146 is illustrated as a component included in the memory 140 in FIG. 3, the present disclosure is not limited thereto. In an embodiment of the present disclosure, the spatial context database 146 may include a database in the augmented reality device 100, which is a separate component from the memory 140. However, the present disclosure is not limited thereto, and in an embodiment of the present disclosure, the spatial context database 146 may include a web storage or a cloud server that is accessible through a network and performs a storage function. In this case, the augmented reality device 100 may communicate with the web storage or the cloud server through the communication interface and perform data transmission to access the spatial context preset.

The processor 130 may obtain a virtual object representing information related to a plurality of objects from the spatial context preset identified from the spatial context database 146. Herein, the ‘virtual object’ may refer to a virtual graphic object including a text, an image, or a combination thereof representing information that is related to an object in a real-world space or is provided by an application executed by the augmented reality device 100. In an embodiment of the present disclosure, the virtual object may be displayed in the form of a graphical user interface (GUI) or a widget. The processor 130 may control the display unit 150 such that the virtual object is displayed through the display unit 150. The display unit 150 may be a display.

The processor 130 may obtain display position information of a virtual object from the spatial context preset and display the virtual object based on the display position information. In an embodiment of the present disclosure, the ‘display position information’ may be set to a relative position based on the position of objects in a real-world space or to a relative position based on the position of the augmented reality device 100. In the case of a virtual object with the display position information set to a relative position based on the position of objects in a real-world space, the processor 130 may identify an object matched to a plurality of objects included in a spatial context preset among the plurality of objects in the real-world space recognized from the image and display the virtual object at a display position of the identified object. In an embodiment of the present disclosure, the processor 130 may display a virtual object at a display position adjacent to an object in the real-world space by projecting at least one of a virtual image, an icon, a letter, a number, a special symbol, and a combination thereof included in a graphic user interface or a widget onto a waveguide of the display unit 150.

In the case of a virtual object with the display position information set to a relative position with respect to the position of the augmented reality device 100, the processor 130 may display the virtual object at a position spaced apart from the current position of the augmented reality device 100 according to a preset distance and direction. The position of the augmented reality device 100 may be obtained through a technology such as simultaneous localization and mapping (SLAM) by using the position information obtained by the position sensor 122 and the measurement value obtained by the IMU sensor 124.

The display unit 150 may be configured to display a virtual object under control by the processor 130. In a case that the augmented reality device 100 is configured as augmented reality glasses, the display unit 150 may be configured as a lens optical system and may include a waveguide and an optical engine. The optical engine may be configured as a projector that generates light of a virtual object including a virtual image, an icon, or a text and projects the light onto a waveguide. The optical engine may include, for example, an image panel, an illumination optical system, and/or a projection optical system. In an embodiment of the present disclosure, the optical engine may be arranged in the frame or temples of the augmented reality glasses. In an embodiment of the present disclosure, under control by the processor 130, the optical engine may display a virtual object by projecting the virtual object onto a waveguide.

However, the present disclosure is not limited thereto, and the display unit 150 may include, for example, at least one of a liquid crystal display, a thin film transistor-liquid crystal display, an organic light emitting diode display, a flexible display, a three-dimensional (3D) display, or an electrophoretic display.

FIG. 4 is a flowchart illustrating a method of identifying, by an augmented reality device 100 according to an embodiment of the present disclosure, matched position relationship information, based on a scene graph of a real-world space.

Operation S410 of FIG. 4 may be an operation that embodies operation S220 illustrated in FIG. 2. Operation S410 may be performed after operation S210 illustrated in FIG. 2 is performed. Operations S420 and S430 of FIG. 4 may be operations that embody operation S230 illustrated in FIG. 2.

In operation S410, the augmented reality device 100 may obtain a scene graph representing the type of object for each of a plurality of objects and the relative position relationship between the plurality of objects. In an embodiment of the present disclosure, the augmented reality device 100 may input an image obtained through a camera into an object recognition model implemented as a deep neural network model and obtain classification information of an object from an image by performing inference using the object recognition model. In an embodiment of the present disclosure, the augmented reality device 100 may obtain information about the type of the plurality of objects as a result of inference through the object recognition model. The augmented reality device 100 may obtain three-dimensional position coordinate value information of objects in a stereo manner and obtain a relative position relationship about distances and directions in a three-dimensional space between the plurality of objects based on the obtained three-dimensional position coordinate value of the objects. The augmented reality device 100 may obtain a scene graph including nodes representing the type of the plurality of objects and edges representing the relative position relationship between the plurality of objects.

In an embodiment of the present disclosure, the scene graph may be implemented in the format of extensible markup language (XML) or the like. A node of the scene graph may include a semantic label representing a type or category of a recognized object, and an edge thereof may represent a relative position relationship including at least one of a distance, a direction vector, or a sign vector in a three-dimensional space between a reference object and another object. In an embodiment of the present disclosure, the edge may include not only the relative position relationship between the objects but also information about the dependency relationship between the objects (e.g., monitor and keyboard).

The scene graph will be described below in detail with reference to FIGS. 5A to 5C together.

FIG. 5A is a diagram illustrating a scene graph 500a obtained by an augmented reality device 100 according to an embodiment of the present disclosure, based on distances between objects.

Referring to FIG. 5A, the scene graph 500a may include a plurality of nodes n₁ to n₅ and a plurality of edges. The plurality of nodes n₁ to n₅ may include attribute information of objects about categories representing types or classification results of a plurality of objects recognized from an image. In an embodiment of the present disclosure, the plurality of nodes n₁ to n₅ may further include information about names, types, or attributes of the plurality of recognized objects. In the embodiment illustrated in FIG. 5A, a first node n₁ may include information about ‘monitor’ that is a type or category of a first object in a real-world space. Likewise, a second node n₂ may include information about ‘notebook’ that is a type or category of a second object, a third node n₃ may include information about ‘keyboard’ that is a type or category of a third object, a fourth node n₄ may include information about ‘mouse’ that is a type or category of a fourth object, and a fifth node n₅ may include information about ‘chair’ that is a type or category of a fifth object.

The edge may include information about the distance between the plurality of nodes n₁ to n₅ in a three-dimensional space. In the embodiment illustrated in FIG. 5A, a first edge may include information about a first distance (dx₁, dy₁, dz₁) between the first node n₁ and the second node n₂ in the three-dimensional space. The first distance (dx₁, dy₁, dz₁) may include information about the distance in the three-dimensional space calculated based on the three-dimensional position coordinate value of each of the first object representing the first node n₁ and the second object representing the second node n₂. Likewise, a second edge may include information about a second distance (dx₂, dy₂, dz₂) between the first node n₁ and the third node n₃ in the three-dimensional space, a third edge may include information about a third distance (dx₃, dy₃, dz₃) between the first node n₁ and the fourth node n₄ in the three-dimensional space, a fourth edge may include information about a fourth distance (dx₄, dy₄, dz₄) between the first node n₁ and the fifth node n₅ in the three-dimensional space, and a fifth edge may include information about a fifth distance (dx₅, dy₅, dz₅) between the second node n₂ and the fifth node n₅ in the three-dimensional space.

FIG. 5B is a diagram illustrating a scene graph 500b obtained by an augmented reality device 100 according to an embodiment of the present disclosure, based on direction vectors of objects.

Referring to FIG. 5B, the scene graph 500b may include a plurality of nodes n₁ to n₅ and a plurality of edges. The plurality of nodes n₁ to n₅ illustrated in FIG. 5B may be the same as those illustrated in FIG. 5A, and thus, redundant descriptions thereof will be omitted for conciseness. The plurality of edges included in the scene graph 500b may include information about direction vectors representing directions between the nodes. In an embodiment of the present disclosure, the direction vector may have both a scalar value and a direction value or may have only information about the direction. In this case, the direction information included in the plurality of edges may be defined by the following equation.

$$\frac{{\vec{v}}_{k}}{\vert {\vec{v}}_{k} \vert} ( k = 1 , 2 , 3 , … ) \qquad [ Equation 1 ]$$

In the embodiment illustrated in FIG. 5B, a first edge may include information about a first direction vector v₁ representing the direction between the first object representing the first node n₁ and the second object representing the second node n₂. Likewise, a second edge may include information about a second direction vector v₂ representing the direction between the first node n₁ and the third node n₃, a third edge may include information about a third direction vector v₃ representing the direction between the first node n₁ and the fourth node n₄, a fourth edge may include information about a fourth direction vector v₄ representing the direction between the first node n₁ and the fifth node n₅, and a fifth edge may include information about a fifth direction vector v₅ representing the direction between the second node n₂ and the fifth node n₅.

FIG. 5C is a diagram illustrating a scene graph 500c obtained by an augmented reality device 100 according to an embodiment of the present disclosure, based on sign vectors of objects.

Referring to FIG. 5C, the scene graph 500c may include a plurality of nodes n₁ to n₅ and a plurality of edges. The plurality of nodes n₁ to n₅ illustrated in FIG. 5C may be the same as those illustrated in FIG. 5A, and thus, redundant descriptions thereof will be omitted for conciseness. The plurality of edges included in the scene graph 500c may include information about sign vectors representing directions between the nodes. The sign vector may be defined as a plus (+) direction or a minus (−) direction with respect to a reference node as in the following equation.

$$sgn ( {\vec{v}}_{k} ) ( + direction / - direction ) , k = 1 , 2 , 3 , … \qquad [ Equation 2 ]$$

In the embodiment illustrated in FIG. 5C, a first edge may include a first sign vector representing the plus (+) direction that is the direction of the second node n₂ with respect to the first object representing the first node n₁. The plus (+) direction and the minus (−) direction may be defined as directions with respect to the reference node. When a counterpart node is arranged to the right side with respect to the reference node, the direction may be defined as plus (+), and when a counterpart node is arranged to the left side with respect to the reference node, the direction may be defined as minus (−). Likewise, a second edge may include a second sign vector representing the plus (+) direction of the third node n₃ with respect to the first node n₁, a third edge may include a third sign vector representing the plus (+) direction of the fourth node n₄ with respect to the first node n₁, a fourth edge may include a fourth sign vector representing the minus (−) direction of the fifth node n₅ with respect to the first node n₁, and a fifth edge may include a fifth sign vector representing the plus (+) direction of the fifth node n₅ with respect to the second node n₂. In the scene graph 500c illustrated in FIG. 5C, the sign vector may be determined according to the reference node, and when the reference node changes, the direction (+direction/−direction) of the sign vector may change into the opposite direction.

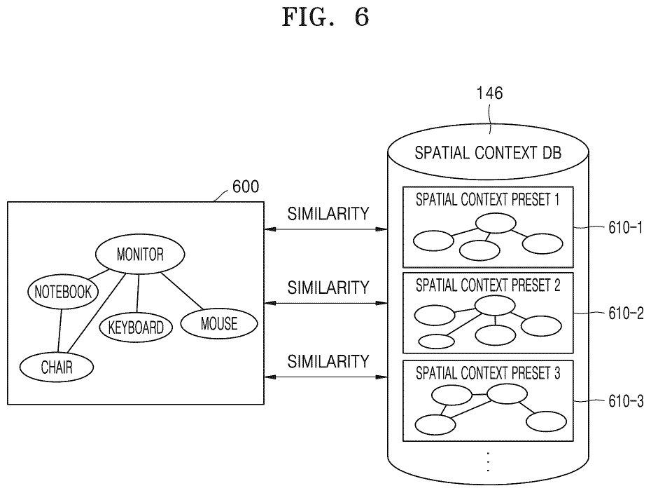

Referring back to FIG. 4, in operation S420, the augmented reality device 100 may measure a similarity by comparing the obtained scene graph with a scene graph about the prestored relative position relationship. In operation S430, the augmented reality device 100 may identify position relationship information matched to the relative position relationship between the plurality of objects, based on the result of comparing the measured similarity with a preset threshold. Operations S420 and S430 will be described below with reference to FIG. 6 together.

FIG. 6 is a diagram illustrating an operation of identifying, by an augmented reality device 100 according to an embodiment of the present disclosure, position relationship information matched to a relative position relationship between a plurality of objects in a real-world space by measuring a similarity of a scene graph 600.

Referring to FIG. 6, the processor 130 (see FIG. 3) of the augmented reality device 100 may measure a similarity by comparing the scene graph 600 obtained based on the relative position relationship between the plurality of objects in the real-world space with a plurality of spatial context presets (610-1, 610-2, 610-3, . . . ) prestored in the spatial context database 146. In an embodiment of the present disclosure, the similarity may be calculated by using the following equation.

$$Similarity = Score ( {Obj}_{i} ⋂ {Obj}_{j} ) + {\sum }_{m} {\sum }_{n} Distance ( {E}_{{i}_{m}} , {E}_{{j}_{n}} ) \qquad [ Equation 3 ]$$

Referring to Equation 3, the similarity may be calculated based on the similarity between a plurality of objects objᵢ (i=1, 2, 3, . . . ) included in the scene graph 600 and objects objⱼ (j=1, 2, 3, . . . ) included in the scene graph of each of the plurality of spatial context presets (601-1, 610-2, 610-3, . . . ) and the distance value between a plurality of edges Eiₘ (m=1, 2, 3, . . . ) of the scene graph 600 and edges Ejₙ (n=1, 2, 3, . . . ) included in the scene graph of each of the plurality of spatial context presets (601-1, 610-2, 610-3, . . . ). The similarity between objects may be calculated as the similarity of node attributes including at least one of the type, category, or number of nodes of the scene graph representing the objects. The similarity of edges may be calculated as the distance difference between the edges; however, the present disclosure is not limited thereto. In an embodiment of the present disclosure, the similarity of edges may be measured as the directional similarity between the edges, and the directional similarity may be calculated as the cosine similarity between the edges.

The processor 130 may compare the calculated similarity with a preset threshold and identify a spatial context preset with the calculated similarity exceeding the threshold among the plurality of spatial context presets (610-1, 610-2, 610-3, . . . ) as a spatial context preset matched to the spatial context recognized from the image.

FIG. 7 is a diagram illustrating an operation of identifying, by an augmented reality device 100 according to an embodiment of the present disclosure, a spatial context preset matched to a spatial context of a real-world space by measuring a similarity of a sub-graph (721, 722, 723) of a scene graph 700.

Referring to FIG. 7, the scene graph 700 may include a plurality of scene graphs having a hierarchical structure. The scene graph 700 may include a main graph 710 and at least one sub-graph (721, 722, 723) that is a lower layer of the main graph 710. In the embodiment illustrated in FIG. 7, the at least one sub-graph (721, 722, 723) may include three sub-graphs. However, the present disclosure is not limited thereto.

The processor 130 (see FIG. 3) of the augmented reality device 100 may measure a similarity by comparing the main graph 710 or the at least one sub-graph (721, 722, 723) with a scene graph 730 of a spatial context preset stored in the spatial context database 146. A particular embodiment in which the processor 130 measures the similarity of the scene graph is the same as that illustrated in FIG. 6, and thus, redundant descriptions thereof will be omitted for conciseness.

The processor 130 may identify a spatial context preset having a scene graph of which the measured similarity exceeds a preset threshold. In the embodiment illustrated in FIG. 7, the processor 130 may identify a second sub-graph 722 with the calculated similarity with respect to the scene graph 730 of the spatial context preset exceeding the threshold among the at least one sub-graph (721, 722, 723) and identify a spatial context preset matched to the entire scene graph 700 based on the identification result.

In the embodiment illustrated in FIG. 7, the augmented reality device 100 may determine a spatial context preset as being matched to the entire scene graph 700 when the similarity with respect to the second sub-graph 722, which is a lower region of the entire scene graph 700, exceeds a preset threshold in the similarity determination of the scene graph. Accordingly, the augmented reality device 100 according to an embodiment of the present disclosure may identify a matched spatial context preset only by the similarity of a sub-graph representing the relative position relationship of some objects, rather than a spatial context according to the relative position relationship of all objects in the real-world space, thereby increasing the recognizability of the spatial context and providing the user with a user experience about the work continuity in various work environments.

FIG. 8 is a flowchart illustrating an operation performed by an augmented reality device 100 according to an embodiment of the present disclosure, depending on whether position relationship information matched to a relative position relationship between a plurality of objects in a real-world space is identified.

Operation S810 may be performed after operation S220 illustrated in FIG. 2 is performed. In operation S810, the augmented reality device 100 may measure a similarity by comparing the obtained scene graph with a scene graph about the prestored relative position relationship. A particular embodiment in which the augmented reality device 100 measures the similarity of the scene graph has been described above in detail with reference to FIG. 6 and FIG. 7, and thus, redundant descriptions thereof will be omitted for conciseness.

In operation S820, the augmented reality device 100 may determine whether position relationship information matched to the scene graph is identified based on the measured similarity. For example, the augmented reality device 100 may determine whether the position relationship information matches the relative relationship between the plurality of recognized objects. In an embodiment of the present disclosure, the augmented reality device 100 may calculate the similarity between a scene graph of a spatial context and a scene graph of a preset spatial context and determine whether a preset spatial context matched to the spatial context is identified based on the calculated similarity. In an embodiment of the present disclosure, the augmented reality device 100 may determine whether a matched spatial context preset is identified based on whether the calculated similarity exceeds a preset threshold.

As a result of the determination, in a case that position relationship information matched to the scene graph is identified, the augmented reality device 100 may display a virtual object obtained from the identified position relationship information at a preset position (operation S830). In an embodiment of the present disclosure, in a case that a spatial context preset matched to the scene graph of the spatial context is identified, the augmented reality device 100 may display a virtual object obtained from the identified spatial context preset at a preset position. Operation S830 may be the same as operation S230 illustrated in FIG. 2, and thus, redundant descriptions thereof will be omitted for conciseness.

As a result of the determination, in a case that position relationship information matched to the scene graph is not identified, the augmented reality device 100 may generate new position relationship information based on the relative position relationship between the plurality of objects (operation S840). In an embodiment of the present disclosure, in a case that a spatial context preset matched to the scene graph of the spatial context is not identified, the augmented reality device 100 may generate a new spatial context preset representing the relative position relationship between the plurality of objects. In this case, the augmented reality device 100 may generate a new scene graph including nodes representing the types or categories of the plurality of objects and edges representing information of the distances, direction vectors, or sign vectors between the plurality of objects.

In operation S850, the augmented reality device 100 may store the new position information. The augmented reality device 100 may store the new spatial context preset in the memory 140. In an embodiment of the present disclosure, the augmented reality device 100 may store the new scene graph as a new spatial context preset in the spatial context database 146 (see FIG. 3).

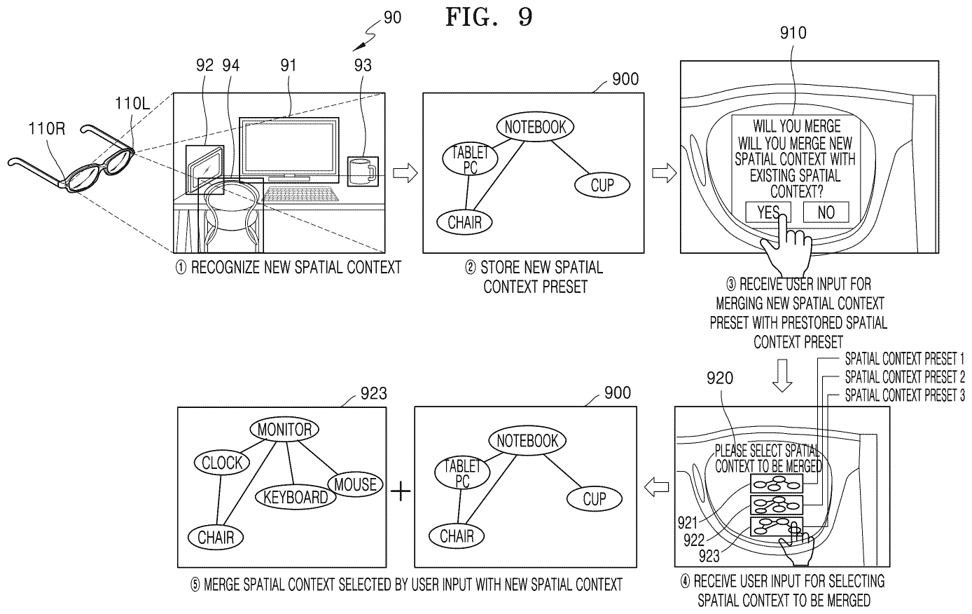

FIG. 9 is a diagram illustrating an operation of merging, by an augmented reality device 100 according to an embodiment of the present disclosure, a new spatial context with an existing spatial context preset.

Referring to FIG. 9, the augmented reality device 100 may recognize a new spatial context representing a relative position relationship of a plurality of objects 91, 92, 93, and 94 in a real-world space 90 (operation \textcircled{1}). The augmented reality device 100 may include a left-eye camera 110L and a right-eye camera 110R and may obtain an image by photographing the plurality of objects 91, 92, 93, and 94 in the real-world space 90 by using the left-eye camera 110L and the right-eye camera 110R. The augmented reality device 100 may recognize the plurality of objects 91, 92, 93, and 94 in the real-world space 90 from the image by performing vision recognition using an artificial intelligence model. In an embodiment of the present disclosure, the augmented reality device 100 may obtain three-dimensional position coordinate values of an object including depth values (z-axis coordinate information) of the plurality of objects 91, 92, 93, and 94 through a stereo vision method by using the left-eye image obtained from the left-eye camera 110L and the right-eye image obtained from the right-eye camera 110R. The augmented reality device 100 may obtain a relative position relationship about the three-dimensional distance and direction between the plurality of objects 91, 92, 93, and 94 based on the obtained three-dimensional position coordinate values. In an embodiment of the present disclosure, the relative position relationship may include information about at least one of a distance, a direction vector, and a sign vector in a three-dimensional space between the plurality of objects 91, 92, 93, and 94.

The augmented reality device 100 may store a new spatial context preset (operation \textcircled{2}). In an embodiment of the present disclosure, the processor 130 (see FIG. 3) of the augmented reality device 100 may obtain a scene graph 900 based on the classification information or type information of the plurality of objects 91, 92, 93, and 94 and the relative position relationship between the plurality of objects 91, 92, 93, and 94. The scene graph 900 may include a plurality of nodes representing the classification information or type of each of the plurality of objects 91, 92, 93, and 94 and a plurality of edges representing the relative position relationship between the plurality of nodes. The processor 130 may store the obtained scene graph 900 as a new spatial context preset in the spatial context database 146 (see FIG. 3).

The augmented reality device 100 may receive a user input for merging the new spatial context preset with a prestored spatial context preset (operation \textcircled{3}). In an embodiment of the present disclosure, the augmented reality device 100 may display a first graphical user interface (GUI) 910 for receiving a user input for determining whether to merge the new spatial context preset with an existing spatial context preset. In the embodiment illustrated in FIG. 9, the first graphic user interface 910 may include a text for receiving a user input for determining whether to merge the contexts with each other, such as “Would you like to merge the new spatial context with the existing spatial context?” The augmented reality device 100 may receive a user's hand pointing input about whether to merge the spatial context preset. However, the present disclosure is not limited thereto, and in an embodiment of the present disclosure, the augmented reality device 100 may receive an input based on the user's gaze direction with respect to the first graphic user interface 910. In this case, the augmented reality device 100 may track the gaze direction of both eyes of the user and determine whether to merge the spatial context based on the position information of a gaze point at which the gaze direction converges among “YES” and “NO” of the first graphic user interface 910.

The augmented reality device 100 may receive a user input for selecting a context preset to be merged with a new spatial context preset from among a plurality of prestored context presets (operation \textcircled{4}). In an embodiment of the present disclosure, the augmented reality device 100 may display a second graphic user interface (GUI) 920 for receiving a user input for selecting one of a plurality of spatial context presets prestored in the spatial context database 146 (see FIG. 3). In the embodiment illustrated in FIG. 9, the second graphic user interface 920 may include a text for receiving a user input for determining a spatial context preset to be merged with a new spatial context preset, such as “Please select a spatial context to be merged.” In an embodiment of the present disclosure, the second graphic user interface 920 may include a graphical object representing a plurality of scene graphs 921, 922, and 923 about a plurality of spatial context presets.

The augmented reality device 100 may receive a user's hand pointing input for selecting a spatial context preset to be merged with a new spatial context preset through the second graphic user interface 920. In the embodiment illustrated in FIG. 9, the augmented reality device 100 may receive a user's hand pointing input for selecting a third scene graph 923 of a third spatial context preset to be merged with a new spatial context preset from among the plurality of scene graphs 921, 922, and 923 about a plurality of spatial context presets included in the second graphic user interface 920. The augmented reality device 100 may select a third spatial context preset corresponding to the third scene graph 923 from among the plurality of spatial context presets based on the received hand pointing input. However, the present disclosure is not limited thereto, and in an embodiment of the present disclosure, the augmented reality device 100 may obtain position information of a gaze point at which the gaze direction converges among the plurality of scene graphs 921, 922, and 923 about the plurality of spatial context presets by tracking the gaze direction of both eyes of the user, and select the third spatial context preset as a spatial context preset to be merged with a new spatial context preset based on the position information of the gaze point.

The augmented reality device 100 may merge a spatial context selected by a user input with a new spatial context (operation \textcircled{5}). In an embodiment of the present disclosure, the processor 130 of the augmented reality device 100 may merge the scene graph 900 of the new spatial context preset with the third scene graph 923 of the third spatial context preset selected by a user input from among the plurality of spatial context presets prestored in the spatial context database 146. In an embodiment of the present disclosure, the merging between the scene graphs may be the parallel merging between the scene graph 900 of the new spatial context preset and the third scene graph 923 of the prestored third spatial context preset; however, the present disclosure is not limited thereto. In a case that the relationship between the scene graph 900 of the new spatial context preset and the third scene graph 923 of the existing spatial context preset is a dependence, the merging between the scene graphs may form a hierarchical structure according to the dependence.

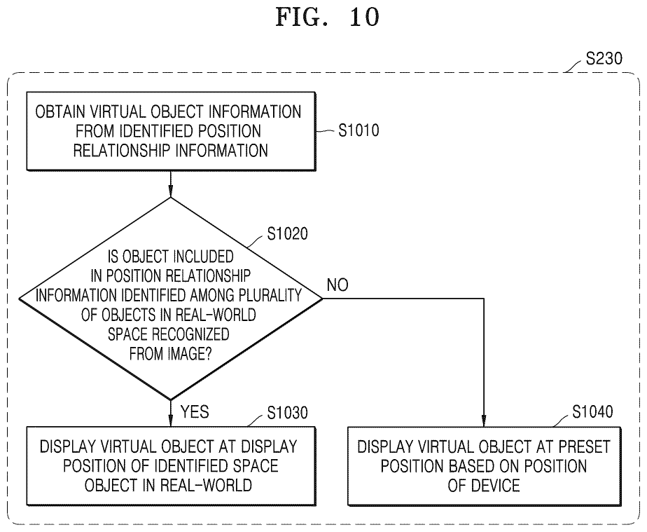

FIG. 10 is a flowchart illustrating a method of displaying, by an augmented reality device 100 according to an embodiment of the present disclosure, a virtual object matched to a spatial context.

Operations S1010 to S1040 of FIG. 10 are operations that embody operation S230 illustrated in FIG. 2.

In operation S1010, the augmented reality device 100 may obtain information of a virtual object from the identified position relationship information. Herein, the ‘virtual object’ may refer to a virtual graphic object including a text, an image, or a combination thereof representing information that is related to an object in a real-world space or is provided by an application executed by the augmented reality device 100. In an embodiment of the present disclosure, the virtual object may be displayed in the form of a graphical user interface (GUI) or a widget.

The augmented reality device 100 may obtain display position information of a virtual object from a spatial context preset. In an embodiment of the present disclosure, the ‘display position information’ may be set to a relative position based on the position of objects in a real-world space or to a relative position based on the position of the augmented reality device 100. In a case that display position information of a virtual object is set to a relative position based on the position of objects in the real-world space, the display position information may include information about the type or category of an object on which the virtual object is to be displayed, and setting information about the direction and spacing distance with respect to the object. For example, the display position information may include information that the first virtual object is located 10 cm apart in the right direction of the monitor. In a case that display position information of a virtual object is set to a relative position based on the position of the augmented reality device 100, the display position information may include information about the direction and distance apart from the position of the augmented reality device 100. For example, the display position information may include three-dimensional position coordinate value information (dx, dy, dz) of the left upper end of the lens unit of the augmented reality device 100.

In operation S1020, the augmented reality device 100 may determine whether an object included in the position relationship information is identified among the plurality of objects in the real-world space recognized from the image. In an embodiment of the present disclosure, the augmented reality device 100 may recognize a plurality of objects in the real-world space from the image obtained through the camera and identify an object included in the spatial context preset among the plurality of recognized objects.

In a case that an object included in the position relationship information is identified from the image, that is, in a case that an object included in the spatial context preset is identified, the augmented reality device 100 may display a virtual object at a display position of the identified object in the real-world space (operation S1030).

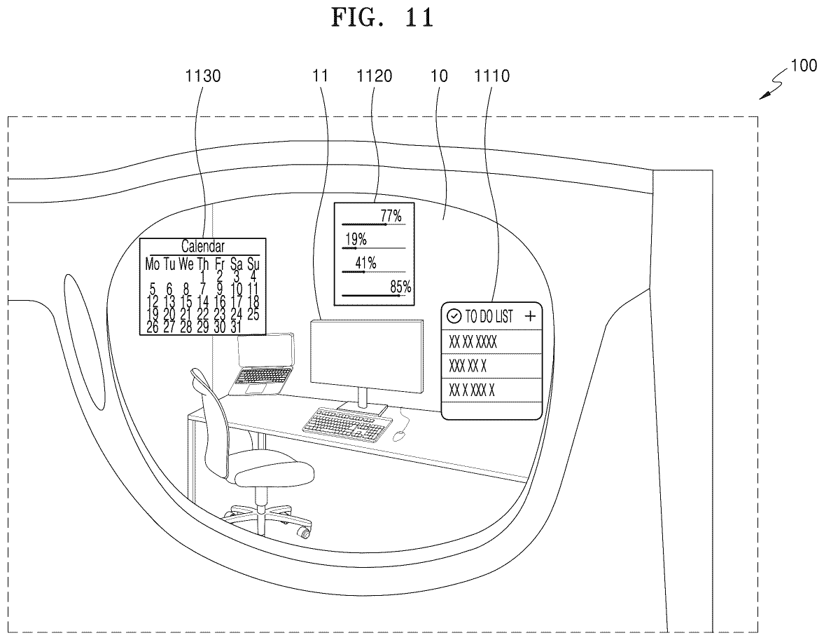

In a case that an object included in the position relationship information is not identified from the imaged, that is, in a case that an object included in the spatial context preset is not identified, the augmented reality device 100 may display a virtual object at a preset position based on the position of the device (operation S1040). Operations S1030 and S1040 will be described below in detail with reference to FIG. 11.

FIG. 11 is a flowchart illustrating an operation of displaying, by an augmented reality device 100 according to an embodiment of the present disclosure, virtual objects 1110, 1120, and 1130 matched to a spatial context.

Referring to FIG. 11, the augmented reality device 100 may obtain information about virtual objects 1110, 1120, and 1130 from a spatial context preset. Based on the obtained information, the augmented reality device 100 may recognize that the display positions of a first virtual object 1110, which is a to-do list widget representing work to do, and a second virtual object 1120, which is a graphic user interface representing the work progress, are set to relative positions based on objects. For example, the display position of the first virtual object 1110 may be set to a position spaced apart by a preset distance in the right direction of the monitor, and the display position of the second virtual object 1120 may be set to a position spaced apart by a preset distance in the upper direction of the monitor. Based on the obtained information, the augmented reality device 100 may recognize that the display position of a third virtual object 1130, which is a calendar widget, is set to a relative position based on the position of the augmented reality device 100. For example, the display position information of the third virtual object 1130 may be set based on the position of the augmented reality device 100 such that the third virtual object 1130 may be displayed at the left upper end position of the lens unit of the augmented reality device 100. In this case, the position information of the augmented reality device 100 may be obtained through a technology such as simultaneous localization and mapping (SLAM) by using the three-dimensional position coordinate information obtained by the position sensor 122 (see FIG. 3) such as a GPS sensor and the measurement value obtained by the IMU sensor 124 (see FIG. 3).

The augmented reality device 100 may recognize a plurality of objects in the real-world space 10 from the image obtained through the camera and identify an object matched to the object included in the spatial context preset among the plurality of recognized objects. In the embodiment illustrated in FIG. 11, the processor 130 (see FIG. 3) of the augmented reality device 100 may recognize a first object (e.g., ‘monitor’) matched to the ‘monitor’ included in the spatial context preset from the image obtained through the camera. The processor 130 may display the first virtual object 1110 and the second virtual object 1120, which are virtual objects with the display position information set based on the positions of objects, at preset positions. For example, the processor 130 may display the first virtual object 1110 at a position spaced apart by a preset position in the right direction of the first object 11 that is a monitor in the real-world space 10 and may display the second virtual object 1120 at a position spaced apart by a preset position in the upper direction of the first object 11.

In a case that the third virtual object 1130 is not matched to the object in the real-world space 10, the augmented reality device 100 may display the third virtual object 1130 at a display position set based on the position of the augmented reality device 100. For example, the processor 130 of the augmented reality device 100 may display the third virtual object 1130 at the left upper end of the lens unit based on the position of the augmented reality device 100.

In an embodiment of the present disclosure, the display unit may include a waveguide and an optical engine, and the processor 130 may display the virtual objects 1110, 1120, and 1130 by projecting light constituting the virtual objects 1110, 1120, and 1130 onto the waveguide by controlling the optical engine.

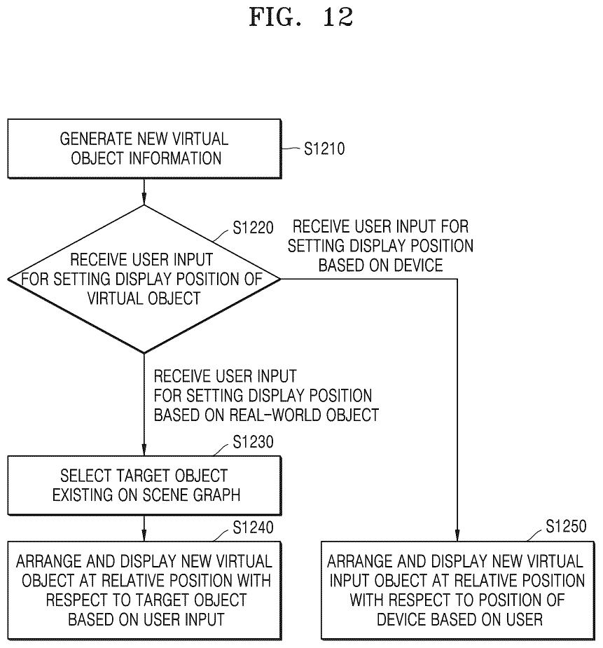

FIG. 12 is a flowchart illustrating a method of displaying, by an augmented reality device 100 according to an embodiment of the present disclosure, a new virtual object.

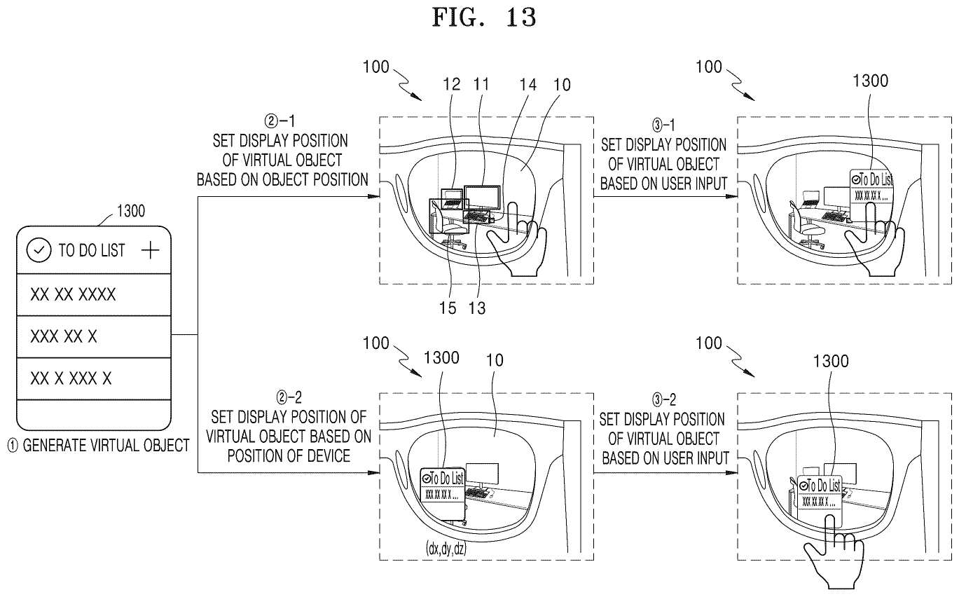

FIG. 13 is a diagram for describing an operation of displaying, by an augmented reality device 100 according to an embodiment of the present disclosure, a new virtual object 1300.

Hereinafter, an operation of generating and displaying a new virtual object 1300 by the augmented reality device 100 will be described with reference to FIG. 12 and FIG. 13 together.

In operation S1210 of FIG. 12, the augmented reality device 100 may generate new virtual object information. The new virtual object may be a graphic user interface (GUI) or a widget; however, the present disclosure is not limited thereto. In the embodiment illustrated in FIG. 13, the new virtual object 1300 may be a to-do list widget representing work to do.

In operation S1220 of FIG. 12, the augmented reality device 100 may receive a user input for setting a display position of a new virtual object. The display position of the new virtual object may be set based on the position of an object in the real-world space or may be set based on the position of the augmented reality device 100.

When receiving a user input for setting the display position based on the real-world object, the augmented reality device 100 may select a target object existing on a scene graph (operation S1230). In an embodiment of the present disclosure, the augmented reality device 100 may recognize a spatial context representing the relative position relationship between objects in the real-world space, obtain a scene graph representing the recognized spatial context, and select a target object for displaying a virtual object among the objects included in the node of the scene graph. Referring to FIG. 13 together, in a case that the display position of a virtual object is set based on the object position (\textcircled{2}-1), the augmented reality device 100 may recognize a plurality of objects 11, 12, 13, 14, and 15 in the real-world space 10 and receive a user input for selecting a target object on which the new virtual object 1300 is to be displayed among the plurality of recognized objects 11, 12, 13, 14, and 15. In an embodiment of the present disclosure, the augmented reality device 100 may receive a user's hand pointing input for selecting any one target object among the plurality of objects 11, 12, 13, 14, and 15. In the embodiment illustrated in FIG. 13, the augmented reality device 100 may receive a user's hand pointing input for selecting a first object 11, which is a monitor, among the plurality of objects 11, 12, 13, 14, and 15.

In operation S1240 of FIG. 12, the augmented reality device 100 may arrange and display a new virtual object at a relative position with respect to a target object based on a user input. In an embodiment of the present disclosure, the augmented reality device 100 may receive a user input for setting a distance and direction in which a new virtual object is to be displayed based on the position of a target object. Referring also to FIG. 13, the augmented reality device 100 may set a display position of the new virtual object 1300 based on a user's hand pointing input (\textcircled{3}-1). In the embodiment illustrated in FIG. 13, the augmented reality device 100 may receive a user's hand pointing input for selecting and dragging the new virtual object 1300 and display the new virtual object 1300 at a position moved by the dragged distance in the right direction of the first object 11 based on the received hand pointing input.

When receiving a user input for setting the display position based on the position of the augmented reality device 100, the augmented reality device 100 may arrange and display a new virtual object at a relative position with respect to the position of the device based on the user input (operation S1250). Referring to FIG. 13 together, the augmented reality device 100 may set the display position of the new virtual object 1300 at a relative position based on the position of the augmented reality device 100 (\textcircled{2}-2). For example, the augmented reality device 100 may set the display position of the new virtual object 1300 such that the new virtual object 1300 is displayed at the left lower end of the lens of the augmented reality device 100. The augmented reality device 100 may set the display position of the new virtual object 1300 based on a user's hand pointing input (\textcircled{3}-2). In the embodiment illustrated in FIG. 13, the augmented reality device 100 may receive a user's hand pointing input for selecting the new virtual object 1300 and dragging the same in the right direction and move the display position of the new virtual object 1300 to a central region of the lower end portion of the lens based on the received hand pointing input.

An aspect of the present disclosure provides a method of providing, by an augmented reality device (100), an augmented reality service matched to a real-world space. An operating method of the augmented reality device (100) may include recognizing a plurality of objects in a real-world space from an image obtained through a camera (110) (S210). The operating method of the augmented reality device (100) may include recognizing a relative position relationship including positions and directions between the plurality of recognized objects (S220). The operating method of the augmented reality device (100) may include displaying a virtual object representing information related to the plurality of recognized objects at a preset position based on information about a prestored relative position relationship (S230).

In an embodiment of the present disclosure, the recognizing of the relative position relationship between the plurality of objects (S220) may include obtaining three-dimensional position coordinate information of each of the plurality of objects from the image, and obtaining the relative position relationship between the plurality of objects, based on the three-dimensional position coordinate information of the plurality of objects.

In an embodiment of the present disclosure, the relative position relationship may include information about at least one of a distance, a direction vector, and a sign vector in a three-dimensional space between the plurality of objects.

In an embodiment of the present disclosure, the recognizing of the relative position relationship between the plurality of objects (S220) may include obtaining a scene graph representing types of the plurality of recognized objects and the relative position relationship between the plurality of objects (S410). The recognizing of the relative position relationship between the plurality of objects (S220) may include measuring a similarity by comparing the obtained scene graph with a prestored scene graph (S420), and identifying position relationship information matched to the relative position relationship, based on a result of comparing the measured similarity with a preset threshold (S430).

In an embodiment of the present disclosure, in the measuring of the similarity of the scene graph (S420), the augmented reality device (100) may calculate a similarity by comparing node attribute information including at least one of classification information, types, and a number of the plurality of objects included in the scene graph with node attribute information included in prestored position relationship information.

In an embodiment of the present disclosure, the obtained scene graph may include at least one sub-graph having a hierarchical structure. The identifying of the position relationship information (S430) may include measuring a similarity by comparing each of the at least one sub-graph with a scene graph of the prestored position relationship information, and identifying position relationship information having a scene graph of which the measured similarity exceeds a preset threshold.

In an embodiment of the present disclosure, the operating method of the augmented reality device (100) may further include generating new position relationship information, based on information about the relative position relationship between the plurality of objects, when position relationship information matched to the relative position relationship between the plurality of recognized objects is not identified (S840). The operating method of the augmented reality device (100) may further include storing the generated new position relationship information (S850).

In an embodiment of the present disclosure, the operating method of the augmented reality device (100) may further include merging the generated new position relationship information with the prestored position relationship information.

In an embodiment of the present disclosure, the displaying of the virtual object (S230) may include obtaining display position information of the virtual object from position relationship information matched to the relative position relationship between the plurality of objects (S1010), identifying an object matched to a plurality of objects included in the position relationship information among the plurality of objects in the real-world space recognized from the image (S1020), and displaying the virtual object at a display position of the object based on the obtained display position information.

In an embodiment of the present disclosure, in the displaying of the virtual object (S230), the augmented reality device (100) may display the virtual object according to a preset distance and direction based on the position of the augmented reality device (100).

Another aspect of the present disclosure provides an augmented reality device (100) for providing an augmented reality service matched to a real-world space. The augmented reality device (100) of the present disclosure may include a camera (110) configured to obtain an image by photographing a real-world space, memory (140) storing at least one instruction, at least one processor (130) configured to execute the at least one instruction, and a display unit (150). The at least one processor (130) may recognize a plurality of objects in a real-world space from an image obtained through the camera (110). The at least one processor (130) may recognize a relative position relationship including positions and directions between the plurality of recognized objects and control the display unit (150) to display a virtual object representing information related to the plurality of recognized objects at a preset position based on information about a relative position relationship prestored in the memory (140).

In an embodiment of the present disclosure, the at least one processor (130) may execute the at least one instruction to obtain a relative position relationship between the plurality of objects based on three-dimensional position coordinate information of each of the plurality of objects obtained from the image. The relative position relationship may include information about at least one of a distance, a direction vector, and a sign vector in a three-dimensional space between the plurality of object.

In an embodiment of the present disclosure, the at least one processor (130) may execute the at least one instruction to obtain a scene graph representing types of the plurality of recognized objects and the relative position relationship between the plurality of objects. The at least one processor (130) may measure a similarity by comparing the obtained scene graph with a scene graph of position relationship information prestored in the memory (140), and identify the position relationship information matched to the relative position relationship between the plurality of objects, based on a result of comparing the measured similarity with a preset threshold.

In an embodiment of the present disclosure, the at least one processor (130) may execute the at least one instruction to calculate a similarity by comparing node attribute information including at least one of classification information, types, and a number of the plurality of objects included in the scene graph with node attribute information included in the prestored position relationship information.

In an embodiment of the present disclosure, the obtained scene graph may include at least one sub-graph having a hierarchical structure. The at least one processor (130) may execute the at least one instruction to measure a similarity by comparing each of the at least one sub-graph with a scene graph of the prestored position relationship information. The at least one processor (130) may identify position relationship information having a scene graph of which the measured similarity exceeds a preset threshold.

In an embodiment of the present disclosure, the at least one processor (130) may execute the at least one instruction to generate new position relationship information, based on information about the relative position relationship between the plurality of objects, when position relationship information matched to the relative position relationship between the plurality of recognized objects is not identified. The at least one processor (130) may store the generated new position relationship information in the memory (140).

In an embodiment of the present disclosure, the at least one processor (130) may execute the at least one instruction to merge the generated new position relationship information with the prestored position relationship information.

In an embodiment of the present disclosure, the at least one processor (130) may execute the at least one instruction to obtain display position information of the virtual object from position relationship information matched to the relative position relationship between the plurality of objects and identify an object matched to a plurality of objects included in the position relationship information among the plurality of objects in the real-world space recognized from the image. The at least one processor (130) may control the display unit (150) to display the virtual object at a display position of the identified object, based on the obtained display position information.

In an embodiment of the present disclosure, the at least one processor (130) may execute the at least one instruction to control the display unit (150) to display the virtual object at a position spaced apart from the position of the augmented reality device (100) according to a preset distance and direction.

Another aspect of the present disclosure provides a computer program product including a computer-readable storage medium. The computer-readable storage medium may include instructions readable by an augmented reality device (100) in order for the augmented reality device (100) to perform an \textcircled{4} of recognizing a plurality of objects in a real-world space from an image obtained through a camera (110), an operation of recognizing a relative position relationship including positions and directions between the plurality of recognized objects, and an operation of displaying a virtual object representing information related to the plurality of recognized objects at a preset position based on information about a prestored relative position relationship.

A program executed by the augmented reality device 100 described herein may be implemented as a hardware component, a software component, and/or a combination of a hardware component and a software component. The program may be performed by any system capable of executing computer-readable instructions.

The software may include computer programs, code, instructions, or a combination of one or more thereof and may configure the processor to operate as desired or may instruct the processor independently or collectively.

The software may be implemented as a computer program including instructions stored in a computer-readable storage medium. The computer-readable recording medium may include, for example, a magnetic storage medium (e.g., read-only memory (ROM), random-access memory (RAM), floppy disk, or hard disk) and an optical readable medium (e.g., CD-ROM or digital versatile disc (DVD)). The computer-readable recording medium may be distributed in network-connected computer systems such that computer-readable codes may be stored and executed in a distributed manner. The recording medium may be readable by a computer, stored in a memory, and executed in a processor.

The computer-readable storage medium may be provided in the form of a non-transitory storage medium. Here, “non-transitory” may merely mean that the storage mediums do not include signals and are tangible, but does not distinguish semi-permanent or temporary storage of data in the storage mediums. For example, the “non-transitory storage medium” may include a buffer in which data is temporarily stored.

Also, the program according to the embodiments described herein may be included and provided in a computer program product. The computer program product may be traded as a product between a seller and a buyer.

The computer program product may include a software program and a computer-readable storage medium with a software program stored therein. For example, the computer program product may include a product (e.g., a downloadable application) in the form of a software program electronically distributed through a manufacturer of the augmented reality device 100 or an electronic market (e.g., Samsung Galaxy Store™). For electronic distribution, at least a portion of the software program may be stored in a storage medium or may be temporarily generated. In this case, the storage medium may be a storage medium of a server of the manufacturer of the augmented reality device 100, a server of the electronic market, or a relay server for temporarily storing the software program.

The computer program product may include a storage medium of a server or a storage medium of the augmented reality device 1000 in a system including the augmented reality device 100 and/or the server. Alternatively, in a case that there is a third device (e.g., a mobile device) communicatively connected to the augmented reality device 100, the computer program product may include a storage medium of the third device. Alternatively, the computer program product may include the software program itself that is transmitted from the augmented reality device 100 to the third device or transmitted from the third device to the electronic device.

In this case, one of the server, the augmented reality device 100, and the third device may execute the computer program product to perform the method according to embodiments of the present disclosure. Alternatively, at least one of the augmented reality device 100 and the third device may execute the computer program product to perform the method according to embodiments of the present disclosure in a distributed manner.

For example, the augmented reality device 100 may execute the computer program product stored in the memory 140 (see FIG. 3) such that another electronic device communicatively connected to the augmented reality device 100 may be controlled to perform the method according to embodiments of the present disclosure.

As another example, the third device may execute the computer program product to control the electronic device communicatively connected to the third device to perform the method according to embodiments of the present disclosure.

In a case that the third device executes the computer program product, the third device may download the computer program product from the augmented reality device 100 and execute the downloaded computer program product. Alternatively, the third device may perform the method according to the described embodiments by executing the computer program product provided in a preloaded state.

While certain embodiments have been described above with reference to the drawings, those of ordinary skill in the art may make various changes and modifications therein from the above description. For example, suitable results may be achieved even when the described technologies are performed in a different order from the described method and/or the components of the described computer system or module are coupled or combined in a different form from the described method or are replaced or substituted by other components or equivalents.

What is claimed is:

1. A method of providing, by an augmented reality device, an augmented reality service matched to a real-world space, the method comprising:
recognizing a plurality of objects in the real-world space from an image obtained via a camera;
recognizing a relative position relationship including positions and directions between the plurality of recognized objects; and
displaying, at a preset position, a virtual object representing information related to the plurality of recognized objects, based on information about a prestored relative position relationship.

2. The method of claim 1, wherein the recognizing of the relative position relationship between the plurality of objects comprises:
obtaining three-dimensional position coordinate information of each of the plurality of recognized objects from the image; and
obtaining the relative position relationship between the plurality of recognized objects, based on the three-dimensional position coordinate information of the each of the plurality of recognized objects.

3. The method of claim 1, wherein the recognizing of the relative position relationship between the plurality of objects comprises:
obtaining a scene graph representing a type of object for each of the plurality of recognized objects and the relative position relationship between the plurality of recognized objects;
measuring a similarity by comparing the obtained scene graph with a prestored scene graph; and
identifying whether position relationship information matches the relative position relationship, based on a result of comparing the measured similarity with a preset threshold.

4. The method of claim 3, wherein the measuring of the similarity by comparing the obtained scene graph with the prestored scene graph comprises calculating the similarity by comparing node attribute information including at least one of classification information, the type of object of each of the plurality of recognized objects, and a number of the plurality of recognized objects included in the obtained scene graph with node attribute information included in the position relationship information.

5. The method of claim 3, wherein the obtained scene graph includes at least one sub-graph having a hierarchical structure, and
wherein the identifying whether the position relationship information matches the relative position relationship comprises:
measuring the similarity by comparing each of the at least one sub-graph with a scene graph of the position relationship information; and
identifying the position relationship information based on a sub-graph of the at least one sub-graph of which the measured similarity exceeds the preset threshold.

6. The method of claim 3, further comprising:
based on identifying that the position relationship information does not match the relative relationship between the plurality of recognized objects, generating new position relationship information, based on information about the relative position relationship between the plurality of recognized objects; and
storing the new position relationship information.

7. The method of claim 1, wherein the displaying of the virtual object comprises:
obtaining display position information of the virtual object from position relationship information matched to the relative position relationship between the plurality of objects;
identifying an object among the plurality of recognized objects that matches an object of a plurality of objects included in the position relationship information; and
displaying the virtual object at a display position of the identified object, based on the obtained display position information.

8. An augmented reality device for providing an augmented reality service matched to a real-world space, the augmented reality device comprising:
a camera configured to obtain an image by photographing the real-world space;
at least one processor including processing circuitry;
memory storing one or more instructions; and
a display,
wherein the one or more instructions, when executed by the at least one processor individually or collectively, causes the augmented reality device to:
recognize a plurality of objects in the real-world space from the image obtained via the camera,
recognize a relative position relationship including positions and directions between the plurality of recognized objects, and
display, through the display, at a preset position, a virtual object representing information related to the plurality of recognized objects, based on information about a relative position relationship prestored in the memory.

9. The augmented reality device of claim 8, wherein the one or more instructions, when executed by the at least one processor individually or collectively, causes the augmented reality device to obtain the relative position relationship between the plurality of recognized objects, based on three-dimensional position coordinate information of each of the plurality of recognized objects obtained from the image,
wherein the relative position relationship includes information about at least one of a distance, a direction vector, and a sign vector in a three-dimensional space between the plurality of objects.

10. The augmented reality device of claim 8, wherein the one or more instructions, when executed by the at least one processor individually or collectively, causes the augmented reality device to:
obtain a scene graph representing a type of object for each of the plurality of recognized objects and the relative position relationship between the plurality of recognized objects;
measure a similarity by comparing the obtained scene graph with a scene graph of position relationship information prestored in the memory; and
identify whether the position relationship information matches the relative position relationship between the plurality of recognized objects, based on a result of comparing the measured similarity with a preset threshold.

11. The augmented reality device of claim 10, wherein the one or more instructions, when executed by the at least one processor individually or collectively, causes the augmented reality device to calculate the similarity by comparing node attribute information including at least one of classification information, the type of object of each of the plurality of the plurality of recognized objects, and a number of the plurality of recognized objects included in the obtained scene graph with node attribute information included in the position relationship information.

12. The augmented reality device of claim 10, wherein the obtained scene graph includes at least one sub-graph having a hierarchical structure, and
the one or more instructions, when executed by the at least one processor individually or collectively, causes the augmented reality device to:
measure the similarity by comparing each of the at least one sub-graph with a scene graph of the position relationship information; and
identify the position relationship information based on a sub-graph of the at least one sub-graph of which the measured similarity exceeds the preset threshold.

13. The augmented reality device of claim 10, wherein the one or more instructions, when executed by the at least one processor individually or collectively, causes the augmented reality device to:
based on identifying that the position relationship information does not match the relative position relationship between the plurality of recognized objects, generate new position relationship information, based on information about the relative position relationship between the plurality of recognized objects; and
store the new position relationship information in the memory.

14. The augmented reality device of claim 8, wherein the one or more instructions, when executed by the at least one processor individually or collectively, causes the augmented reality device to:
obtain display position information of the virtual object from position relationship information matched to the relative position relationship between the plurality of objects and identify an object among the plurality of recognized objects that matches an object of a plurality of objects included in the position relationship information; and
display, through the display, the virtual object at a display position of the identified object, based on the obtained display position information.

15. A non-transitory computer-readable medium storing at least one instruction that, when executed by at least one processor, cause an augmented reality device to perform operations comprising:
recognizing a plurality of objects in a real-world space from an image obtained via a camera;
recognizing a relative position relationship including positions and directions between the plurality of recognized objects; and
displaying, at a preset position, a virtual object representing information related to the plurality of recognized objects, based on information about a prestored relative position relationship.

16. The method of claim 1, further comprising:
receiving a user input for setting a display position of a new virtual object;
based on receiving the user input for setting the display position of the new virtual object, selecting a target object existing on a scene graph representing the relative position relationship between the plurality of recognized objects; and
displaying the new virtual object at a relative position with respect to the target object.

17. The method of claim 1, further comprising:
receiving a user input for setting a display position of a new virtual object based on a position of the augmented reality device; and
based on receiving the user input for setting the display position of the new virtual object based on the position of the augmented reality device, display the new virtual object at a relative position with respect to the position of the augmented reality device.

18. The non-transitory computer-readable medium of claim 15, wherein the recognizing of the relative position between the plurality of objects comprises:
obtaining three-dimensional position coordinate information of each of the plurality of recognized objects from the image; and
obtaining the relative position relationship between the plurality of recognized objects, based on the three-dimensional position coordinate information of the each of the plurality of recognized objects.

19. The non-transitory computer-readable medium of claim 15, wherein the recognizing of the relative position relationship between the plurality of objects comprises:
obtaining a scene graph representing a type of object for each of the plurality of recognized objects and the relative position relationship between the plurality of recognized objects;
measuring a similarity by comparing the obtained scene graph with a prestored scene graph; and
identifying whether position relationship information matches the relative position relationship, based on a result of comparing the measured similarity with a preset threshold.

20. The non-transitory computer-readable medium of claim 19, wherein the measuring of the similarity of the scene graph comprises calculating the similarity by comparing node attribute information including at least one of classification information, the type of object of each of the plurality of recognized objects, and a number of the plurality of recognized objects included in the obtained scene graph with node attribute information included in a position relationship information.
